(19) United States
(12) Patent Application Publication
(10) Pub. No.: US 2010/0108469 A1
(43) Pub. Date: May 6, 2010

(54) MOVING DEVICE

(75) Inventor: Martinus Cornelis Ophey, St. Oedenrode (NL)

Correspondence Address: BARNES & THORNBURG LLP, 11 SOUTH MERIDIAN, INDIANAPOLIS, IN, 46204, US

(73) Assignee: Assembleon B.V., Veldhoven (NL)

(21) Appl. No.: 12/607,779

(22) Filed: Oct. 28, 2009

(30) Foreign Application Priority Data
Oct. 28, 2008 (NL) 1036120

(51) Int. Cl. B65G 54/02

(52) U.S. Cl. 198/619

(57) ABSTRACT

A moving device comprises at least a first element which is movable in a direction of movement by means of a drive unit, which first element at least comprises at least one first magnetic part. The moving device further comprises a second element, with respect to which the first element is movable at least from at least one operative position spaced from the second element to a rest position near the second element. The second element comprises at least one second magnetic part, which is polarized in a polarization direction opposed to the polarization direction of the first magnetic part. The polarization directions extend transversely to the direction of movement and also transversely to surfaces of the first and second elements that are positioned opposite each other in the rest position.

The invention relates to a moving device comprising at least one first element which is movable in a direction of movement by means of a drive unit, which first element at least comprises at least one first magnetic part, said moving device further comprising a second element, which second element at least comprises at least one second magnetic part, whilst the first element is movable with respect to the second element at least from at least one operative position spaced from the second element to a rest position near the second element.

With such a moving device, which is known from U.S. Pat. No. 6,334,523, a number of first elements are moved with respect to a number of second elements. In addition, the first elements are also movable with respect to each other, being provided with magnets that repel each other. The first elements further comprise first magnetic parts, which are polarised in the direction of movement. The second elements comprise a coil, which is to be energized. The first elements repel each other, thereby imparting movement to each other.

The object of the invention is to provide a moving device which may comprise a single first element and a single second element, in which relatively little energy is required for driving the device.

This object is accomplished with the moving device according to the invention in that the second magnetic part is polarized in a polarization direction opposed to the polarization direction of the first magnetic part, which polarization directions extend transversely to the direction of movement and also transversely to surfaces of the first and second elements that are positioned opposite each other in the rest position.

When the first element is moved from the operative position to the rest position near the second element, repulsive forces act between the first and the second element due to the opposite polarization directions of the magnetic parts, which forces have a decelerating effect on the movement of the first element. The first element can thus be decelerated to a stationary position relative to the second element. When subsequently the first element is moved from the rest position to the operative position by means of the drive unit, an acceleration is imparted to the first element as a result of the aforesaid repulsive forces. As a result of the deceleration forces and acceleration forces acting on the first element, less energy is required for driving the element than in the situation in which the first element must be decelerated and accelerated, respectively, by the drive unit itself.

In the rest position, the repulsive forces in the direction of movement and in a direction opposite to the direction of movement are substantially of the same magnitude, so that the first element has a semi-stable position relative to the second element.

It has to be noted that with a moving device which is known from the applicant's European patent application EP-A1-1 840 503 a first element provided with a component pickup and placement unit is moved between a rest position near a component feeder to an operative position above a substrate conveying device. In the rest position, a component is picked up from the component feeder by the component pickup and placement unit, whereupon the component pickup and placement unit is moved to the desired operative position above a substrate supported by the substrate conveying device. The picked-up component is then positioned at the desired position on the substrate by the component pickup and placement unit. In the rest position, the component pickup and placement unit must be decelerated to a stationary position relative to the component feeder, after which it can pick up a component from the component feeder. Following that, the component pickup and placement unit must be accelerated again so as to be moved to the desired operative position in as short a time as possible. Because of the relatively high deceleration and acceleration forces, a relatively great deal of energy is required for driving the component pickup and placement unit. As a result of the energy dissipation, the motor temperatures will run up relatively high, which can only be prevented by decreasing the decelerations and accelerations.

The moving device can also be used with any device in which two elements are to be moved relative to each other from an operative position to a rest position and vice versa. Near the rest position, the first element must be decelerated to a stationary position relative to the second element and be accelerated again from said rest position.

The moving device can for example be used in a rotary indexing mill in the production of light bulbs.

One embodiment of the moving device according to the invention is characterised in that the second element comprises two magnetic parts, which, in the rest position, are positioned opposite surfaces of the first element that face away from each other.

Because of the presence of the two magnetic parts on either side of the first element, the repulsive forces in the polarization directions substantially cancel each other, whilst the repulsive forces in the direction of movement are retained.

As a result of the presence of the magnetic parts, virtually no forces are exerted by the first element on the second element, or vice versa, in the polarisation directions transversely to the direction of movement.

The magnetic parts of the second element preferably have the same polarisation direction.

It is also possible, however, for the first element to comprise two magnetic parts of opposite polarisation, in which case the second element will also comprise magnetic parts of opposite polarisation. The opposing magnetic parts of the first element and the second element must also have opposite polarization directions.

Another embodiment of the moving device according to the invention is characterised in that the first element is movable with respect to the second element at least from a first operative position on a first side of the second element, via the rest position, to a second operative position on a second side remote from said first side.

In this way it is possible to stop the first element temporarily at a rest position between the first and the second operative position, and subsequently set the element moving again. Upon movement of the element from the first operative position to the rest position, deceleration forces are exerted on the first element by the magnetic parts, whilst acceleration forces are exerted on the first element by the magnetic parts upon subsequent movement of the element from the rest position to the second operative position.

Another embodiment of the moving device according to the invention is characterised in that the length of the second magnetic part of the second element is greater than the length of the first magnetic part of the first element.

Since the second magnetic part is longer than the first magnetic part, the semi-stable position of the first element is readily ensured in the rest position, whilst edge effects of the second magnetic part have virtually no effect on the first magnetic part. Because the length of the first magnetic part is moreover relatively short in relation to the length of the second magnetic part, the weight of the first magnetic part, which is connected to the moving first element, is relatively low, as a result of which the forces required for driving the first element are smaller than in a situation in which the first magnetic part is smaller than the second magnetic part.

Yet another embodiment of the moving device according to the invention is characterised in that the first and the second magnetic parts comprise permanent magnets.

Since the magnetic parts are permanent magnets, they need not be separately provided with energy, which would be the case if the magnetic parts were to comprise electromagnets.

Yet another embodiment of the moving device according to the invention is characterised in that the moving device further comprises a component pickup and placement unit comprising the first element, a substrate conveying device and a component feeder, which component placement unit is positioned near a component feeder in the rest position, whilst the component placement unit is positioned near the substrate conveying device in the operative position.

Such a moving device is suitable for placing components on a substrate. The component pickup and placement unit can be decelerated to a stationary position relatively quickly by the magnetic parts near the rest position and be accelerated again relatively quickly from said rest position, with relatively little energy being required for driving the first element.

The invention will now be explained in more detail with reference to the drawings, in which:

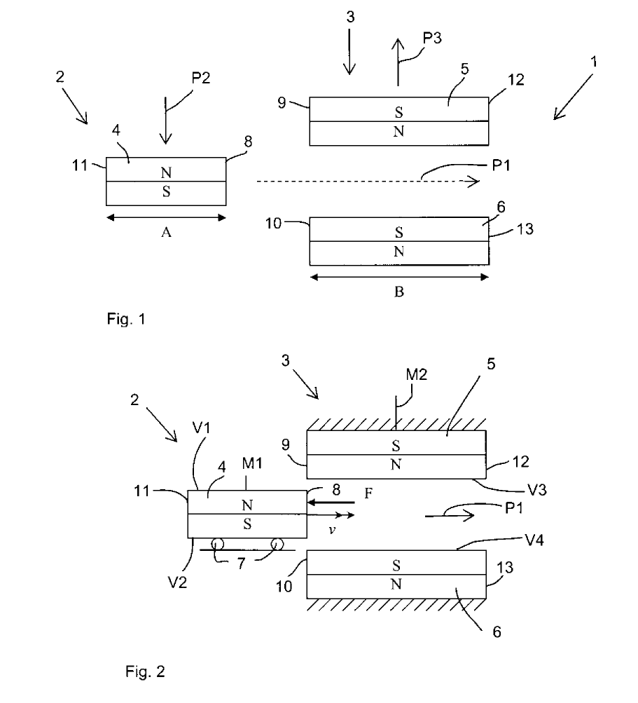

FIGS. 1-6 show a first embodiment of a device according to the invention, in which the first element is shown in different positions relative to the second element;

FIG. 7 shows a diagram of the force exerted in the direction of movement by the magnetic parts;

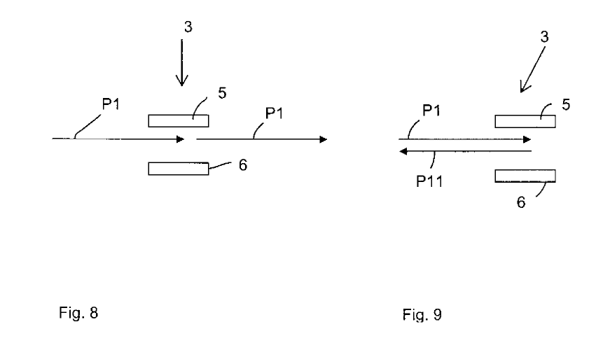

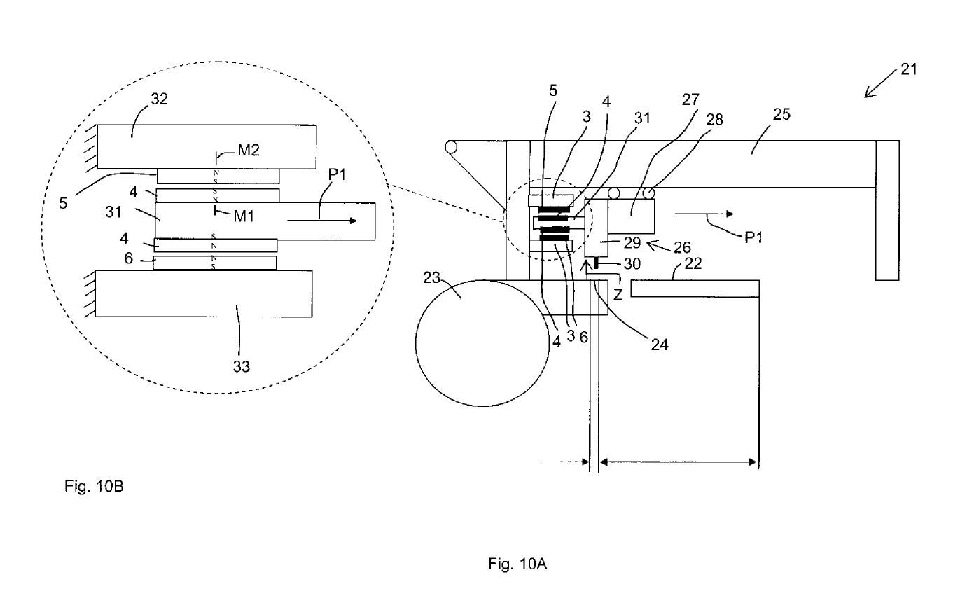

FIGS. 8 and 9 show two different applications of the device shown in FIGS. 1-6;

FIG. 10A shows a side view of another embodiment of a moving device according to the invention;

FIG. 10B shows a larger-scale detail of the moving device shown in FIG. 10A.

Like parts are indicated by the same numerals in the figures.

FIGS. 1-6 show a moving device 1 according to the invention, which comprises a first element 2, which is movable with respect to a second element in a direction of movement opposite to the direction indicated by the arrow P1. The first element 2 comprises a first magnetic part 4, which is polarized in polarization direction P2 transversely to the direction of movement P1. The first magnetic part 4 has a length A, seen in the direction of movement P1.

The second element 3 comprises two spaced-apart second magnetic parts 5, 6, which are identically polarized. The polarization direction of the second magnetic parts 5, 6 is oriented transversely to the direction of movement P1, opposite to the polarization direction P2 of the first magnetic part 4. The second magnetic parts 5, 6 have a length B, seen in the direction of movement P1.

The diagram shown in FIG. 7 is based on a length A of 60 mm and a length B of 90 mm.

The first element 2 is provided with a drive unit (not shown), by means of which the first element can be moved in a direction of movement opposite to the direction indicated by the arrow P1.

In the position of the first element 2 relative to the second element 3 that is shown in FIG. 1, the first element 2 is spaced from the second element 3 by a relatively large distance. In the position that is shown in FIG. 1, hardly any forces are exerted on the first magnetic part 4 by the second magnetic parts 5, 6.

In FIG. 7, the position shown in FIG. 1 is indicated at I.

As FIG. 2 clearly shows, the second magnetic parts 5, 6 of the second element 3 are rigidly connected to a base, so that a constant spacing between the two opposite magnetic parts 5, 6 is ensured. The first element 2 is movable with respect to the second element 3, which is schematically illustrated by means of wheels 7. From the position shown in FIG. 1, the first element 2 is moved at a velocity v in the direction indicated by the arrow P1. As soon as the right-hand side 8 of the first magnetic part 4 comes near the left-hand sides 9, 10 of the second magnetic parts 5, 6, magnetic forces will be exerted on the first element 2. The magnitude of said forces depends on the specific position of the first magnetic part 4 relative to the second magnetic parts 5, 6. As is clearly shown in FIG. 2, the north poles N of the magnetic parts 5, 6 and the south poles S of the magnetic parts 4, 6 lie near each other in the relative positions of the elements 2, 3, resulting in a repulsive force F being exerted on the first element 2 in a direction opposite to the direction of movement P1. As a result of said force F, the first element 2 will decelerate.

In the position shown in FIG. 2, the centre M1 of the first element 2 is spaced from the centre M2 of the second element 3 by a distance of 0.5×60+0.5×90=60 mm. This position is indicated at II in FIG. 7.

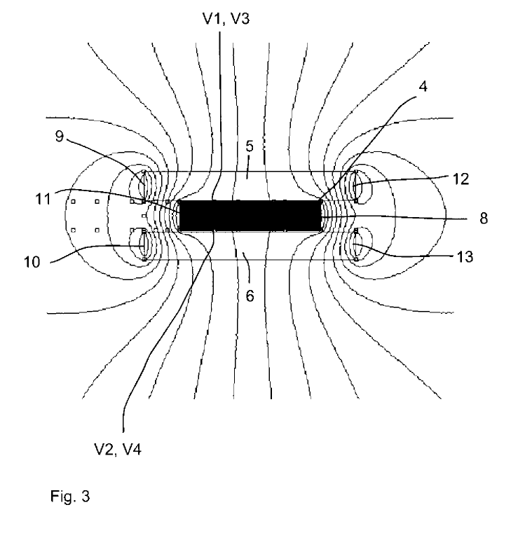

In the relative positions shown in FIG. 3, the first magnetic part 4 of the first element 2 is positioned centrally between the second magnetic parts 5, 6 of the second element 2, seen in the direction of movement P1. In this position, the spacing between the centre M1 and the centre M2 amounts to zero. This position is indicated at III in FIG. 7.

In the position shown in FIG. 3, parallel surfaces V1, V2 of the first magnetic part 4 are positioned opposite parallel surfaces V3, V4 of the second magnetic part 5 and the second magnetic part 6, respectively.

In FIG. 3, the magnetic lines of the magnetic field generated by the magnetic parts 4, 5, 6 are shown. As the figure clearly shows, edge effects occur near the left-hand sides 9, 10 and the right-hand sides 12, 13 of the second magnetic parts 5, 6. Since the lengths B of the second magnetic parts 5, 6 are greater than the length A of the first magnetic part 4, said edge effects have virtually no effect on the magnetic forces acting on the second magnetic part 4 in the position shown in FIG. 3.

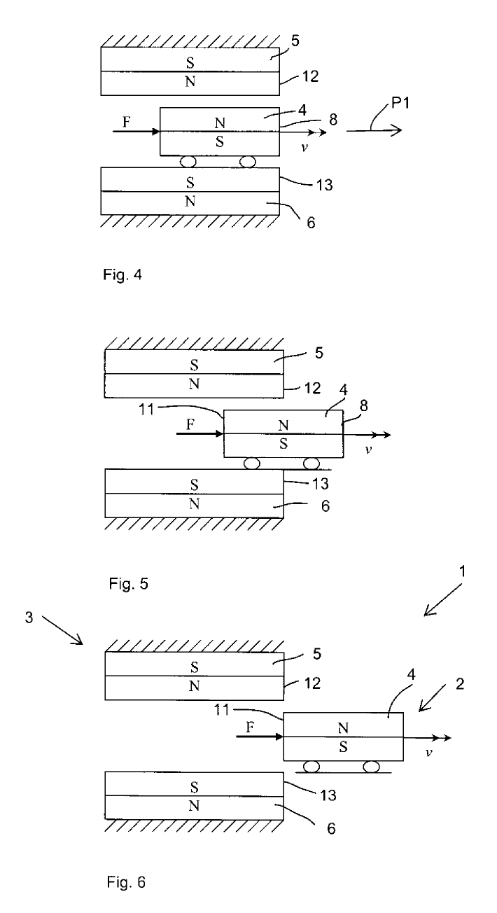

Upon further movement of the first element 2 from the rest position in the direction indicated by the arrow P1 at a desired velocity v, the second magnetic parts 6 exert a repulsive force F on the first magnetic part 4. The direction of the repulsive force F corresponds to the direction of movement P1 and the velocity v. The force F assists in moving the first element 2 from the rest position shown in FIG. 3 to the position shown in FIG. 4. The force F exerts an acceleration force on the first element 2 and the first magnetic part 4.

In the position shown in FIG. 4, the spacing between the centre M1 and the centre M2 is 15 mm, which position is indicated at IV in FIG. 7.

In the position shown in FIG. 5, the spacing between the centre M1 and the centre M2 is 45 mm, which position is indicated at V in FIG. 7.

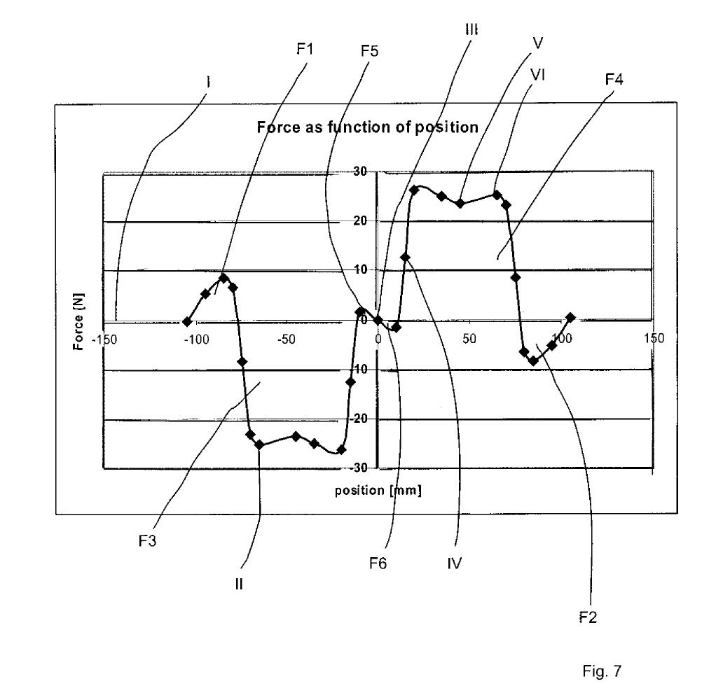

In the position shown in FIG. 6, the first element 2 occupies substantially the same position relative to the second element 3 as in the position shown in FIG. 2, with the first element 2 being positioned on the left-hand side of the second element 3 in FIG. 2 whilst being located on the right-hand side of the second element 3 in the position shown in FIG. 6. In this position, the left-hand side 11 of the first magnetic part 4 is located near the right-hand sides 12, 13 of the second magnetic parts 5, 6. This position is indicated at VI in FIG. 7.

As already indicated above, FIG. 7 shows the force exerted on the first magnetic part 4 by the magnetic parts 5, 6 in dependence on the position of the centre M1 of the first magnetic part 4 relative to the centre M2 of the second magnetic parts 5, 6. As FIG. 7 clearly shows, an attractive force F1, F2 is exerted on the first element 2 from a distance of about 110 mm upon movement of the first element 2 in the direction of the second element, which attractive force F1, F2 draws the first element 2 in the direction of the second element 3. Said forces F1, F2 result from the edge effects acting near the ends 9, 10 and 12, 13, respectively, of the second magnetic parts 5, 6.

Once the first element 2 is positioned closer to the second element 3, with the spacing between the centres M1 and M2 decreasing, a repulsive force F3, F4, respectively, in the direction away from the second magnetic parts 5, 6 is exerted on the first element 2. Said repulsive forces F3 and F4, respectively, are significantly larger than the attractive forces F1 and F2, respectively.

Near the centre, where the spacing between the centre M1 of the first magnetic part 4 and the centre M2 of the second magnetic parts 5, 6 amounts to zero, relatively small attractive forces F5 and F6, respectively, occur, which forces are directed towards the centre M2 of the second magnetic parts 5, 6.

Because of the occurrence of said forces F5, F6, a good semi-stable position of the first element 2 in relation to the second element 3 is ensured. If F5 and F6 amount to zero, a stable, forceless situation will occur at position III.

In the diagram shown in FIG. 7, the repulsive force F at the position indicated at VI is larger than at the position indicated at V. This is caused by parasitic effects resulting from, for example, the specific shape of the various parts, the selected materials, etc.

The magnitude of the force F and the exact form of the diagram depends, among other factors, on the strength of the magnetic parts 4, 5, 6, the lengths A and 2 of the magnetic parts 4, 5, 6, etc.

FIG. 8 schematically shows applications of the device 1 shown in FIGS. 1-6, in which the first element 2 is moved in the direction indicated by the arrow P1, from a first operative position to the left of the second element 3 to a rest position between the magnetic parts 5, 6 of the second element, with the magnetic parts exerting a deceleration force on the first element 2. When subsequently the first element 2 is moved in the direction indicated by the arrow P1, from the rest position to a second operative position to the right of the second element 3, acceleration forces are exerted on the first element 2 by the magnetic parts 5, 6. From said second operative position, the first element 2 can be moved in a direction opposite to the direction indicated by the arrow P1, via the rest position, to the first operative position on the left-hand side of the second element 3.

If said operative positions are fixed positions, elements corresponding to the second element 3 may again be disposed near said operative positions, if desired, by means of which elements the first element 2 is decelerated to a stationary position or accelerated.

In the application of the device 1 of FIGS. 1-6 as shown in FIG. 9, the first element 2 is first moved in the direction indicated by the arrow P1 to a rest position between the magnetic parts 5, 6, whereupon the first element 2 is moved in a direction of movement P11, opposite to the direction indicated by the arrow P1.

FIGS. 10A and 10B show another embodiment of a moving device 21 according to the invention, which comprises a substrate conveying device 22, by means of which substrates (not shown) can be moved in a direction transversely to the plane of the drawing. The moving device 21 further comprises a component feeder 23, by means of which for example components packaged in tapes are fed in steps to a component pickup position 24. The moving device 21 further comprises a frame 25, with respect to which a component pickup and placement unit 26 is movable in a direction opposite to the direction indicated by the arrow P1. The component pickup and placement unit 26 comprises a slide 27, which is movable with respect to the frame 25 via a guide 28. The component pickup and placement unit 26 further comprises a unit 29, which is connected to the slide 27, and a nozzle 30, which is movable in a direction opposite to the direction indicated by the arrow Z. By means of said nozzle 30, a component can be picked up from the pickup position 24, which component 30 is subsequently to be placed on a substrate supported by the substrate conveying device 22. The device 21 as described so far is known per se, for example from the applicant's aforesaid European patent application EP-A1-1 840 503. The slide 27 further comprises a horizontally extending element 31, which is provided with first magnetic parts 4 on either side thereof. In the rest position shown in FIG. 10A, the first magnetic parts 4 are positioned opposite second magnetic parts 5, 6, which are connected to the frame 25 via supports 23, 33, respectively. The frame 25 and the second magnetic parts 5, 6 connected thereto via the support 32, 33 correspond to the second element of the moving device 1 shown in FIGS. 1-6

The component pickup and placement unit 26 is decelerated upon being moved from an operative position above the substrate conveying device 22 to a rest position above the component pickup position 24, whilst the component placement unit 26 is accelerated upon being moved from the rest position to the operative position as a result of the forces exerted on the magnetic parts 4 by the magnetic parts 5, 6. At the rest position, in which the nozzle 30 is positioned opposite the pickup position 24, the centre M1 of the first magnetic parts 4 is positioned opposite the centre M2 of the second magnetic parts 5, 6.

The magnetic parts 4, 5, 6 are made up of permanent magnets. The element 31 and the supports 32, 33 can be made of magnetically conductive iron for passing through the magnetic fields, for example for the purpose of saving on magnetic material for the magnetic parts 4, 5, 6 or reducing edge effects.

It is also possible, however, to use electromagnets, which are provided with the required electrical drive and control means. Besides extra costs, the use of such drive and control means also means a higher energy consumption and an increased development of heat.

1. A moving device comprising at least one first element which is movable in a direction of movement by means of a drive unit, which first element at least comprises at least one first magnetic part, said moving device further comprising a second element, which second element at least comprises at least one second magnetic part, whilst the first element is movable with respect to the second element at least from at least one operative position spaced from the second element to a rest position near the second element, characterised in that the second magnetic part is polarized in a polarization direction opposed to the polarization direction of the first magnetic part, which polarization directions extend transversely to the direction of movement and also transversely to surfaces of the first and second elements that are positioned opposite each other in the rest position.

2. A moving device according to claim 1, characterised in that the second element comprises two magnetic parts, which, in the rest position, are positioned opposite surfaces of the first element that face away from each other.

3. A moving device according to claim 2, characterised in that the magnetic parts of the second element have the same polarisation direction.

4. A moving device according to claim 1, characterised in that the first element is movable with respect to the second element at least from a first operative position on a first side of the second element, via the rest position, to a second operative position on a second side remote from said first side.

5. A moving device according to claim 1, characterised in that the length of the second magnetic part of the second element is greater than the length of the first magnetic part of the first element.

6. A moving device according to claim 1, characterised in that the first and the second magnetic parts comprise permanent magnets.

7. A moving device according to claim 1, characterised in that the first magnetic part and the second magnetic part are positioned symmetrically relative to each other in the position of rest.

8. A moving device according to claim 1, characterised in that the moving device further comprises a component pickup and placement unit comprising the first element, a substrate conveying device and a component feeder, which component placement unit is positioned near a component feeder in the rest position, whilst the component placement unit is positioned near the substrate conveying device in the operative position.

9. A moving device according to claim 2, characterised in that the first element is movable with respect to the second element at least from a first operative position on a first side of the second element, via the rest position, to a second operative position on a second side remote from said first side.

10. A moving device according to claim 2, characterised in that the length of the second magnetic part of the second element is greater than the length of the first magnetic part of the first element.

11. A moving device according to claim 2, characterised in that the first and the second magnetic parts comprise permanent magnets.

12. A moving device according to claim 2, characterised in that the first magnetic part and the second magnetic part are positioned symmetrically relative to each other in the position of rest.

13. A moving device according to claim 2, characterised in that the moving device further comprises a component pickup and placement unit comprising the first element, a substrate conveying device and a component feeder, which component placement unit is positioned near a component feeder in the rest position, whilst the component placement unit is positioned near the substrate conveying device in the operative position.

14. A moving device according to claim 3, characterised in that the first element is movable with respect to the second element at least from a first operative position on a first side of the second element, via the rest position, to a second operative position on a second side remote from said first side.

15. A moving device according to claim 3, characterised in that the length of the second magnetic part of the second element is greater than the length of the first magnetic part of the first element.

16. A moving device according to claim 3, characterised in that the first and the second magnetic parts comprise permanent magnets.

17. A moving device according to claim 3, characterised in that the first magnetic part and the second magnetic part are positioned symmetrically relative to each other in the position of rest.

18. A moving device according to claim 3, characterised in that the moving device further comprises a component pickup and placement unit comprising the first element, a substrate conveying device and a component feeder, which component placement unit is positioned near a component feeder in the rest position, whilst the component placement unit is positioned near the substrate conveying device in the operative position.
